(19) United States
(12) Patent Application Publication
(10) Pub. No.: US 2023/0291045 A1
(43) Pub. Date: Sep. 14, 2023

(54) BATTERY MODULE OF BATTERY-REPLACEMENT OUTDOOR POWER SUPPLY

(71) Applicant: SHANGHAI RUNHOOD POWER CO., LTD., SHANGHAI (CN)

(72) Inventors: ZHONGSHU CHEN, SHANGHAI (CN); XIAODONG WANG, SHANGHAI (CN); WEI QIN, SHANGHAI (CN)

(21) Appl. No.: 18/063,689

(22) Filed: Dec. 9, 2022

(30) Foreign Application Priority Data
Mar. 8, 2022 (CN) 202220490893.2

(51) Int. Cl. H01M 50/204; H01M 50/172

(52) U.S. Cl. CPC H01M 50/204; H01M 50/172; H01M 2004/028

(57) ABSTRACT

Embodiments of the present disclosure relates to the technical field of mobile power supply, and a battery module of a battery-replacement outdoor power supply is provided. The battery module of the battery-replacement outdoor power supply is incorporated into a battery compartment of the battery-replacement outdoor power supply and includes a battery pack, a housing, and a quick connector penetrating through the housing. One end of the quick connector is electrically connected to the battery pack, and the other end of the quick connector is detachably connected to a slot in the battery compartment.

### CROSS-REFERENCE TO RELATED APPLICATION

The present application claims the benefit of priority under the Paris Convention to Chinese Utility Model No. 202220490893.2 filed on Mar. 8, 2022, which is incorporated herein by reference in its entirety.

### TECHNICAL FIELD

The present disclosure relates to the technical field of mobile power supply, and more particularly to a battery module of a battery-replacement outdoor power supply.

### BACKGROUND

With the support of various intelligent electronic devices, outdoor activities such as camping and photography have gradually become leisure activities of multiple families. In various outdoor activities, people need to use computers, ovens and other equipment that need a large amount of electricity, while portable power supplies meet people's demand for electricity in various outdoor activities.

However, the inventor found that the portable power supply does not support battery replacement, and the entire portable power supply will fail when the power runs out or the battery is damaged, so the entire portable power supply needs to be replaced, which is unable to meet the demand of people for the large amount of electricity, thereby affecting users' experience and having a high power supply cost.

### SUMMARY

The present disclosure is intended to provide a battery module of a battery-replacement outdoor power supply, so that the battery module of the battery-replacement outdoor power supply is able to be directly disassembled and replaced, and the demand of people for a large amount of electricity is met by using a plurality of battery modules supporting quick replacement, thereby effectively alleviating users' anxiety about the amount of electricity, improving the uses' experience, and reducing the power supply cost of the portable power supply.

To solve the above technical problems, embodiments of the present disclosure provide a battery module of a battery-replacement outdoor power supply for being incorporated into a battery compartment of the battery-replacement outdoor power supply, including: a battery pack; a housing; a quick connector penetrating through the housing, wherein one end of the quick connector is electrically connected to the battery pack, and the other end of the quick connector is detachably connected to a slot in the battery compartment.

The present disclosure provides a battery module of a battery-replacement outdoor power supply. The housing of the battery module of a battery-replacement outdoor power supply is provided with a quick connector penetrating through the housing. The quick connector has two opposite ends, one end is electrically connected to the battery pack inside the battery module, and the other end is matched with the slot in the battery compartment, so that detachably connection between the quick connector and the battery module is achieved. In addition, the quick connector supports charged inserting. In this way, when the battery module runs out of power or is damaged, the battery module of the battery-replacement outdoor power supply is able to be directly disassembled and replaced, and the demand of people for a large amount of electricity is met by using a plurality of battery modules supporting quick replacement, thereby effectively alleviating users' anxiety about the amount of electricity, improving the uses' experience, and reducing the power supply cost of the portable power supply.

In some embodiments, the housing includes a housing body, a first cover plate, a second cover plate and a plug-in panel; wherein the housing body is a groove having openings, the first cover plate is connected to the housing body, the housing body and the first cover plate corporately form a hollow structure having two opposite openings, and the battery pack is disposed inside the hollow structure; and wherein the second cover plate covers one of the two opposite openings of the hollow structure, the plug-in panel covers the other of the two opposite openings of the hollow structure, the plug-in panel is provided with a panel through hole penetrating through the plug-in panel, and the quick connector is fixed in the panel through hole.

The housing includes the housing body, the first cover plate, the second cover plate and the plug-in panel. The housing body and the first cover plate are connected to form the hollow structure having two opposite openings. The battery pack is disposed inside the hollow structure. The second cover plate covers one of the two opposite openings of the hollow structure, and the plug-in panel covers the other of the two opposite openings of the hollow structure. In this way, the battery pack is able to be enclosed inside the housing to protect the battery pack. The plug-in panel is provided with the panel through hole penetrating through the plug-in panel, and the quick connector is fixed in the panel through hole. In this way, when the quick connector is damaged, the quick connector is able to be directly removed and replaced, without replacing the entire housing, so as to reduce the maintenance cost of the battery module of the battery-replacement outdoor power supply.

In some embodiments, the battery module of the battery-replacement outdoor power supply further includes a handle, wherein the handle is provided with a groove having an opening exposed outside the hollow structure, and the groove of the handle is provided with a guide mechanism; and wherein the handle is integrated with the housing body or connected to one of the second cover plate, the housing body, and the first cover plate.

The battery module of the battery-replacement outdoor power supply includes the handle, and the handle is connected to the second cover plate, the housing body or the first cover plate. The handle is provided with the groove, the opening of the groove is exposed outside the hollow structure, and the guide mechanism is provided in the cavity of the housing. When the user disassembles or installs the battery module of the battery-replacement outdoor power supply, the handle is able to provide a grasping space for the user, and the guide mechanism is able to guide the user to grasp the handle smoothly. The handle is independent from the housing and is then connected to the housing, so that only one of the handle and the housing needs to be replaced when the handle or the housing is damaged, without replacing them all, thereby saving the cost.

In some embodiments, the handle is provided with lock holes respectively on outer wall surfaces adjacent to a surface where the groove is provided, and wherein each of the lock holes is configured to fitting and fixing a respective lock catch in the battery compartment. The handle is provided with lock holes, the lock holes are respectively located on the outer wall surfaces adjacent to the surface where the groove is located, and the lock holes are configured to cooperate with the lock catches of the battery compartment to fix the battery module of the battery-replacement outdoor power supply. In this way, when the battery module of the battery-replacement outdoor power supply is installed in the battery-replacement outdoor power supply, the lock holes and the lock catches cooperate to fix the battery module, so as to prevent the battery module from being separated from the battery-replacement outdoor power supply and ensure continuous power supply of the battery-replacement outdoor power supply.

In some embodiments, the housing body is provided with positioning grooves and the first cover plate is provided with positioning protrusions, and wherein the positioning protrusions are in one-to-one correspondence with the positioning grooves, and each of the positioning protrusions is embedded in a respective positioning groove. The housing body is provided with the positioning grooves and the first cover plate is provided with the positioning protrusions. When the housing body is connected with the first cover plate, the positioning grooves and the positioning protrusions are in one-to-one correspondence, and the positioning protrusions are respectively embedded in the positioning grooves. Through the matching of the positioning protrusions and the positioning grooves, the assembly accuracy of the housing body and the first cover plate is improved, and the overall structural strength of the housing is improved.

In some embodiments, an inner wall surface of the housing body facing the battery pack is provided with at least one first reinforcing rib, and an inner wall surface of the first cover plate facing the battery pack is provided with at least one second reinforcing rib. The structural strength of the housing body is improved by disposing at least one first reinforcing rib on the inner wall surface of the housing body facing the battery pack, and the structural strength of the first cover plate is improved by disposing at least one second reinforcing rib on the inner wall surface of the first cover plate facing the battery pack. In this way, the strength of the housing body and first cover plate is improved through the reinforcing ribs, so as to form stable protection for the battery pack. In addition, the first reinforcing rib and the second reinforcing rib are able to abut the battery pack so as to fix the battery pack and prevent the battery pack from being displaced.

In some embodiments, a plurality of first reinforcing ribs and a plurality of second reinforcing ribs are provided, and wherein the plurality of first reinforcing ribs are in one-to-one correspondence with the plurality of second reinforcing ribs, and each of the plurality of first reinforcing ribs abuts a respective second reinforcing rib. Both the first reinforcing ribs and the second reinforcing ribs are plural. When the housing body is connected with the first cover plate, the first reinforcing ribs and the second reinforcing ribs are in one-to-one correspondence and abut each other. In this way, the assembly accuracy of the housing body and the first cover plate is improved through the correspondence and fitting of the first and second reinforcing ribs, thereby improving the structural strength of the housing.

In some embodiments, the battery pack includes a battery control board, a plurality of cells, a connection conductor and a plurality of insulating sheets, and the plurality of cells constitute a cell pack; wherein the cell pack has a positive electrode and a negative electrode opposite to each other, and the connection conductor includes a positive electrode connection conductor, a negative electrode connection conductor and a plurality of series connection conductors; wherein the positive electrode connection conductor is connected to the positive electrode of the cell pack and is disposed at one end of the cell pack, the negative electrode connection conductor is connected to the negative electrode of the cell pack and is disposed at the other end of the cell pack opposite to the positive electrode connection conductor, and each of the plurality of series connection conductors is disposed at opposite sides of the cell pack and is configured for series connection of the plurality of cells; wherein the battery control board is disposed at a side of the positive electrode connection conductor facing away from the cell pack and a side of the negative electrode connection conductor facing away from the cell pack, the battery control board is connected to the positive electrode connection conductor and the negative electrode connection conductor, the battery control board is connected to each of the plurality of cells, and the battery control board is connected to the quick connector; and wherein the plurality of insulating sheets comprises a first insulating sheet, a second insulating sheet, and a third insulating sheet, wherein the first insulating sheet is sandwiched between the positive electrode connection conductor and the battery control board and extends from the positive electrode connection conductor to the negative electrode connection conductor, the second insulating sheet is disposed between the negative electrode connection conductor and the battery control board, and the third insulating sheet is disposed at a side of the cell pack facing away from the battery control board and sandwiched between the plurality of series connection conductor and an inner wall of the housing.

In the battery module of the battery-replacement outdoor power supply, the battery pack further includes the battery control board, the plurality of cells, the connection conductor and the plurality of insulating sheets, and the plurality of cells constitute the cell pack. The battery control board is connected to the cell pack, and the positive electrode and the negative electrode of the cell pack are opposite to each other. The connection conductor includes the positive electrode connection conductor, the negative electrode connection conductor and the plurality of series connection conductors. The positive electrode connection conductor is connected to the positive electrode of the cell pack, the negative electrode connection conductor is connected to the negative electrode of the cell pack, and the plurality of series connection conductors connect the plurality of cells in series. The battery control board is connected to the positive electrode connection conductor and the negative electrode connection conductor, and the battery control board is connected to each of the plurality of cells. The battery control board has a battery management function, which is used to monitor parameters of each cell in the battery pack, including but not limited to voltage, current and temperature, and make certain adaptive adjustment. The battery control board is also connected with the quick connector. The electric energy of the battery pack passes through the battery control board in the form of current and is output through the quick connector. When the battery pack is damaged due to excessive temperature or current, the power supply of the battery pack is able to be cut off through the battery control board, so as to protect the safety of the battery-replacement outdoor power supply and the user. The first insulating sheet is sandwiched between the positive electrode connection conductor and the battery control board and extends from the positive electrode connection conductor to the negative electrode connection conductor, the second insulating sheet is disposed between the negative electrode connection conductor and the battery control board, and the third insulating sheet is disposed at a side of the cell pack facing away from the battery control board and sandwiched between the plurality of series connection conductor and an inner wall of the housing. The insulating sheets separate the cell pack from other components in the battery pack, so as to prevent the battery pack from short-circuiting during use and improve the safety of the product.

In some embodiments, the battery pack further includes an upper cell bracket and a lower cell bracket, and the upper cell bracket and the lower cell bracket define an accommodation space, and the plurality of cells are disposed in the accommodation space. By using the cell brackets to combine and fix the cells, the space is effectively used, the assembly of the cells is accurate and stable, and the stability of the cell pack is improved.

In some embodiments, the housing is further provided with a power switch and an electric quantity display device. The power switch and the electric quantity display device are provided on the housing of the battery module, so that independent control of the battery module is realized through the power switch during use, and a real-time electric quantity of the battery module is obtained by the user through the electric quantity display device, which is convenient for the user to determine the time for replacing the battery module.

### BRIEF DESCRIPTION OF THE DRAWINGS

FIG. 1 is an exploded view of a structure of a battery module of a battery-replacement outdoor power supply.

FIG. 2 is an exploded view of a structure of a battery pack.

FIG. 3 is a schematic structural diagram of connection between a cell pack and a circuit control board.

FIG. 4 is a schematic structural diagram of connection between of a cell pack and a positive electrode connection conductor.

FIG. 5 is a schematic structural diagram of positioning of a cell pack and a first insulating sheet.

FIG. 6 is an exploded view of a structure of a battery module of a battery-replacement outdoor power supply having a second cover plate.

FIG. 7 is a schematic structural diagram in which a housing body is integrally formed with a second cover plate.

FIG. 8 is a schematic structural diagram of a plug-in panel and a quick connector.

FIG. 9 is a schematic structural diagram of a housing body.

FIG. 10 is a schematic structural diagram of a first cover plate.

FIG. 11 is a partially enlarged view of an S1 region shown in FIG. 9.

FIG. 12 is a partially enlarged view of an S3 region shown in FIG. 10.

FIG. 13 is an exploded view of a structure of a battery module of a battery-replacement outdoor power supply having a handle.

FIG. 14A is a schematic structural diagram of a side of a handle facing away from a housing;

FIG. 14B is a schematic structural diagram of a side of the handle connecting to the housing;

FIG. 15 is a partially enlarged view of an S2 region shown in FIG. 9.

### DETAILED DESCRIPTION OF THE EMBODIMENTS

In order to make the objectives, technical solutions and advantages of the embodiments of the present disclosure clearer, various embodiments of the present disclosure are described in detail below with reference to the accompanying drawings. Those of ordinary skill in the art should appreciate that many technical details have been proposed in various embodiments of the present disclosure for the reader to better understand the present disclosure. However, the technical solutions claimed in the present disclosure is able to be realized even without these technical details and various changes and modifications based on the following embodiments.

In embodiments of the present disclosure, the terms “on,” “under,” “left,” “right,” “front,” “rear,” “top,” “bottom,” “inner,” “outer,” “middle,” “vertical,” “horizontal,” “lateral,” “longitudinal” and the like indicate location or position relations based on the locations or positions relations shown in the accompanying drawings. These terms are primarily intended to better describe the present disclosure and its embodiments, and are not intended to define that the indicated device, element or component must have a particular orientation or be constructed and operated in a particular orientation.

Moreover, some of the terms described above may be used to indicate other meanings in addition to the location or position relations, for example the term “on” may also be used to denote certain attachment or connection relationships in some cases. For those of ordinary skill in the art, the specific meaning of these terms in the present disclosure may be understood on a case-by-case basis.

In addition, the terms “installation,” “disposing,” “arranging,” “opening,” “connection,” “connecting” shall be understood broadly. For example, it may be a fixed connection, a detachable connection, or a monolithic construction, or it may be a mechanical connection, or an electrical connection, or it may be a direct connection, an indirect connection via an intermediate medium, or an internal communication between two devices, elements or components. For those of ordinary skill in the art, the specific meaning of these terms in the present disclosure may be understood on a case-by-case basis.

Furthermore, the terms “first,” “second,” etc., are mainly used to distinguish between different devices, elements, or components (particular types and constructions thereof may be the same or may be different) and are not used to indicate or imply the relative importance and number of the devices, elements, or components. The term “a plurality of” means two or more than two, unless otherwise specified.

The technical scheme of the present disclosure is further described with reference to the embodiments and the accompanying drawings.

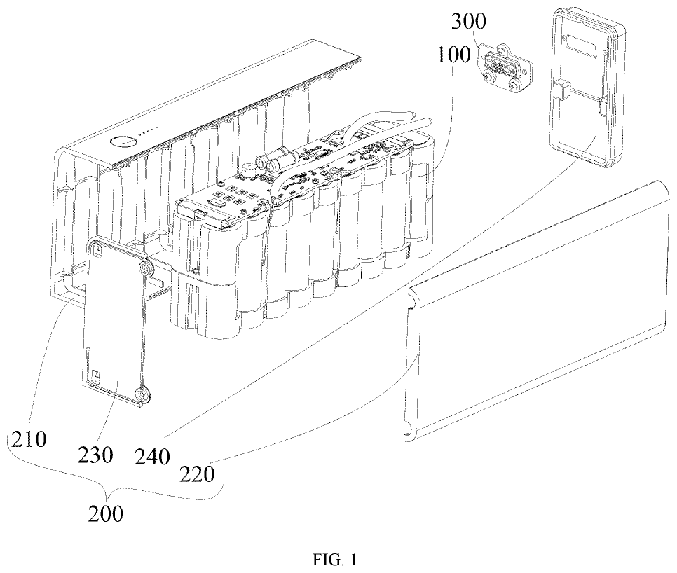

Embodiments of the present disclosure relate to a battery module of a battery-replacement outdoor power supply. As shown in FIG. 1, the battery module of the battery-replacement outdoor power supply includes a battery pack 100, a housing 200 and a quick connector 300. The housing 200 surrounds the battery pack 100, the quick connector 300 penetrates through the housing 200, one end of the quick connector 300 is electrically connected to the battery pack 100, and the other end of the quick connector 300 is detachably connected to a slot in the battery compartment.

In the embodiments of the present disclosure, the housing of the battery module of the battery-replacement outdoor power supply is provided with the quick connector 300 penetrating through the housing 200. The quick connector 300 has two opposite ends, one end is electrically connected to the battery pack 100 inside the battery module, and the other end is matched with the slot in the battery compartment, so that detachably connection between the quick connector and the battery module is achieved. In addition, the quick connector 300 supports charged inserting. In this way, when the battery module runs out of power or is damaged, the battery module of the battery-replacement outdoor power supply is able to be directly disassembled and replaced, and the demand of people for a large amount of electricity is met by using a plurality of battery modules supporting quick replacement, thereby effectively alleviating users' anxiety about the amount of electricity, improving the uses' experience, and reducing the power supply cost of the portable power supply.

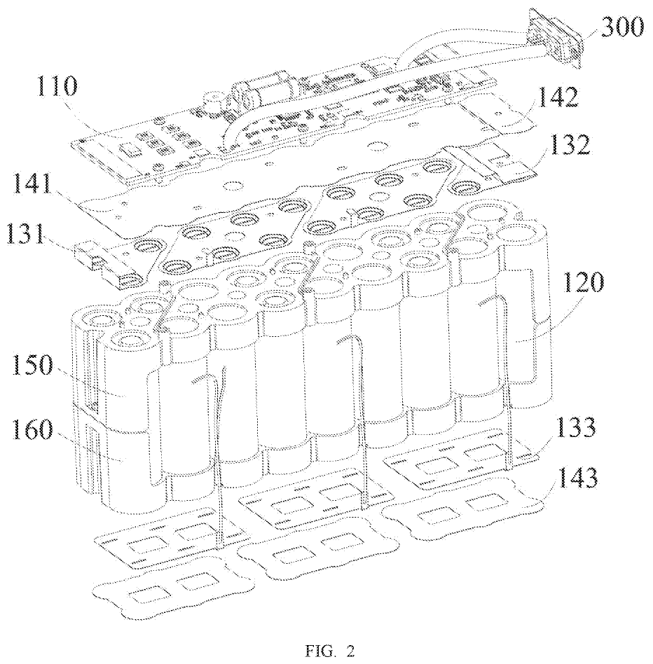

In some embodiments, as shown in FIG. 2, in the battery module of the battery-replacement outdoor power supply, the battery pack 100 further includes a battery control board 110, a plurality of cells 120, a connection conductor and a plurality of insulating sheets, and the plurality of cells 120 constitute a cell pack. The battery control board 110 is connected to the cell pack, and a positive electrode and a negative electrode of the cell pack are opposite to each other. The connection conductor includes a positive electrode connection conductor 131, a negative electrode connection conductor 132 and a plurality of series connection conductors 133. The positive electrode connection conductor 131 is connected to the positive electrode of the cell pack, the negative electrode connection conductor 132 is connected to the negative electrode of the cell pack, and the plurality of series connection conductors 133 connect the plurality of cells 120 in series. The battery control board 110 is connected to the positive electrode connection conductor 131 and the negative electrode connection conductor 132, and the battery control board 110 is also connected to each of the plurality of cells 120. The battery control board 110 has a battery management function for monitoring parameters of each cell 120 in the battery pack 100, including but not limited to voltage, current and temperature, and make certain adaptive adjustment. The battery control board 110 is also connected with the quick connector 300. The electric energy of the battery pack 100 passes through the battery control board 110 in the form of current and is output through the quick connector 300. When the battery pack 100 is damaged due to excessive temperature or current, the power supply of the battery pack 100 is able to be cut off through the battery control board 110, so as to protect the safety of the battery-replacement outdoor power supply and the user. A first insulating sheet 141 is sandwiched between the positive electrode connection conductor 131 and the battery control board 110 and extends from the positive electrode connection conductor 131 to the negative electrode connection conductor 132, a second insulating sheet 142 is disposed between the negative electrode connection conductor 132 and the battery control board 110, and a third insulating sheet 143 is disposed at a side of the cell pack facing away from the battery control board 110 and sandwiched between the plurality of series connection conductor 133 and an inner wall of the housing 200. The insulating sheets 141, 142, 143 separate the cell pack from other components in the battery pack 100, so as to prevent the battery pack 100 from short-circuiting during use and improve the safety of the battery module.

In some embodiments, the battery pack 100 further includes an upper cell bracket 150 and a lower cell bracket 160, and the upper cell bracket 150 and the lower cell bracket 160 are connected to define an accommodation space, and the cell pack composed of the plurality of cells 120 is disposed in the accommodation space. By disposing the cell pack in the accommodation space enclosed by the upper cell bracket 150 and the lower cell bracket 160, stability of the assembly of the cell pack is ensured, thereby ensuring stability of the power supply of the battery module of the battery-replacement outdoor power supply.

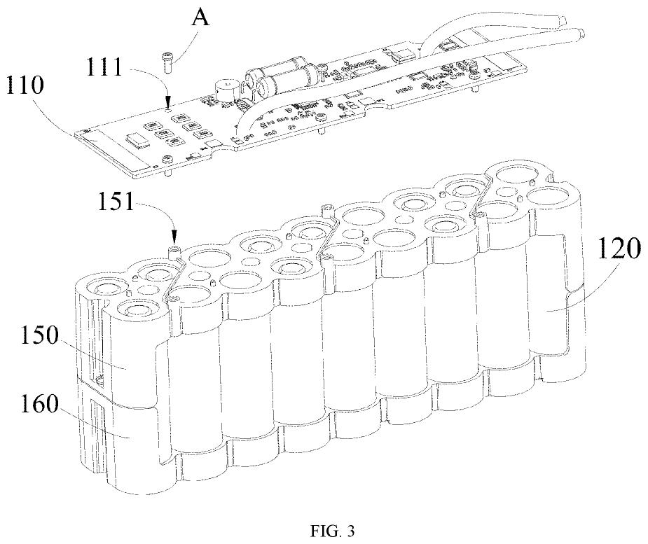

In some embodiments, as shown in FIG. 3, the upper cell bracket 150 is provided with at least one first connection hole 151, and the battery control board 110 is provided with a plurality of second connection holes 111 penetrating through the battery control board 110. The plurality of first connection holes 151 are in one-to-one correspondence with the plurality of second connection holes 111. A respective one of the at least one first connection member ‘A’ (as an example, FIG. 3 only shows one first connection member) passes through a respective second connection hole 111 and enters a respective first connection hole 151 corresponding to the respective second connection hole 111 to fix the battery control board 110 on the upper cell bracket 150. By connecting through the first connection members A to fix the battery control board 110 on the upper cell bracket 150, it is ensured that the battery control board 110 is able to maintain a relatively stable state when moving the battery module of the battery-replacement outdoor power supply, thereby preventing the battery control board 110 from being displaced or even damaged.

In some embodiments, the number of the first connection holes 151 and the number of the second connection holes 111 may not be equal, as long as the first connection members A are able to fix the battery control board 110 on the upper cell bracket 150 through the first connection holes 151 and the second connection holes 111, so as to maintain the stability of the battery control board 110, which is not specifically limited in the embodiments of the present disclosure.

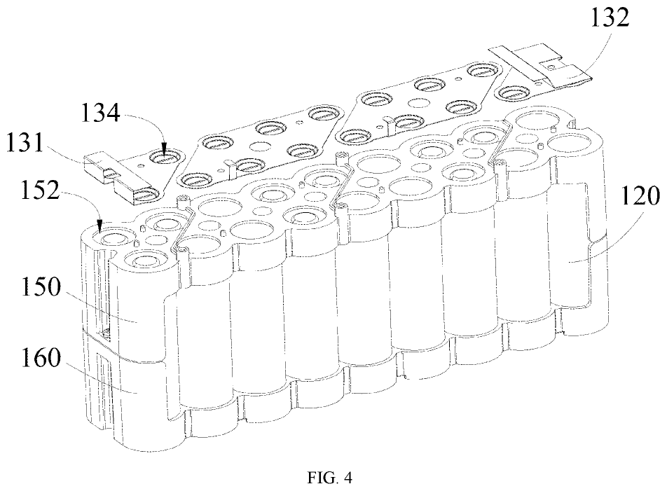

In some embodiments, as shown in FIG. 4, the upper cell bracket 150 is further provided with a plurality of first positioning holes 152 penetrating through the upper cell bracket 150, and the first positioning holes 152 expose the end of the cells 120. The positive electrode connection conductor 131 and the negative electrode connection conductor 132 are provided with a plurality of guide slots 134 with openings facing away from the upper cell bracket 150, the plurality of guide slots 134 are in one-to-one correspondence with the first positioning holes 152, and slot bottoms of the guide slots 134 pass through the first positioning holes 152 and contact the ends of the cells 120. The upper cell bracket 150 is provided with the plurality of first positioning holes 152 penetrating the upper cell bracket 150, and the guide slots 134 in one-to-one correspondence with the first positioning holes 152 are provided on the connection conductor, so that the slot bottoms of the guide slots 134 pass through the first positioning holes 152 and contact the cells 120. In this way, the assembly accuracy of the upper cell bracket 150 and the connection conductor is improved, the structural stability of the battery pack is improved, and the guide slots 134 make the connection conductor and the cells 120 more firmly when being welded.

It should be understood that connection arrangement between the lower cell bracket 160 and the series connection conductors 133 may also be the same as that between the upper cell bracket 150 and the positive electrode connection conductor 131 and negative electrode connection conductor 132 as described above, so that the assembly accuracy of the lower cell bracket 160 and the series connection conductors 133 is ensured, which is not specifically limited in the embodiments of the present disclosure.

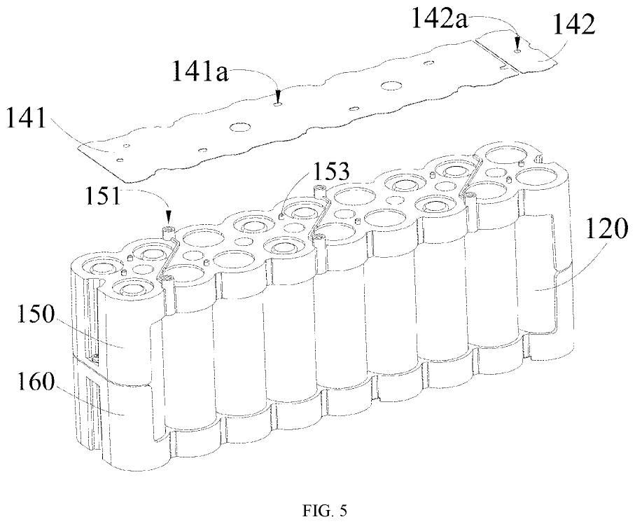

In some embodiments, as shown in FIG. 5, the first insulating sheet 141 is provided with a plurality of second positioning holes 141a, the second insulating sheet 142 is provided with one or more third positioning holes 142a, and the upper cell bracket 150 is provided with a plurality of first positioning pillars 153. Some of the plurality of first positioning pillars 153 are in one-to-one correspondence with the second positioning holes 141a and are connected to the first insulating sheet 141 through the second positioning holes 141a, and other of the first positioning pillars 153 on the upper cell bracket 150 is connected to the second insulating sheet 142 through the one or more third positioning holes 142a. In this way, the assembly accuracy of the first insulating sheet 141, the second insulating sheet 142 and the upper cell bracket 150 is improved, thereby improving the electrical safety performance of the battery module of the battery-replacement outdoor power supply.

In some embodiments, the number of the first positioning pillars 153 may be smaller than the positioning holes, as long as there are corresponding first positioning pillars 153 matched with the positioning holes so that the first insulating sheet 141 and the second insulating sheet 142 are accurately assembled with the upper cell bracket 150, which is not specifically limited in the embodiments of the present disclosure.

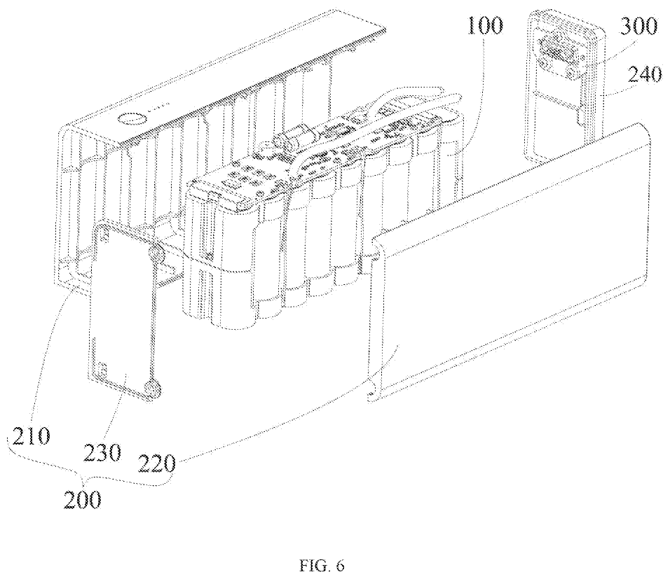

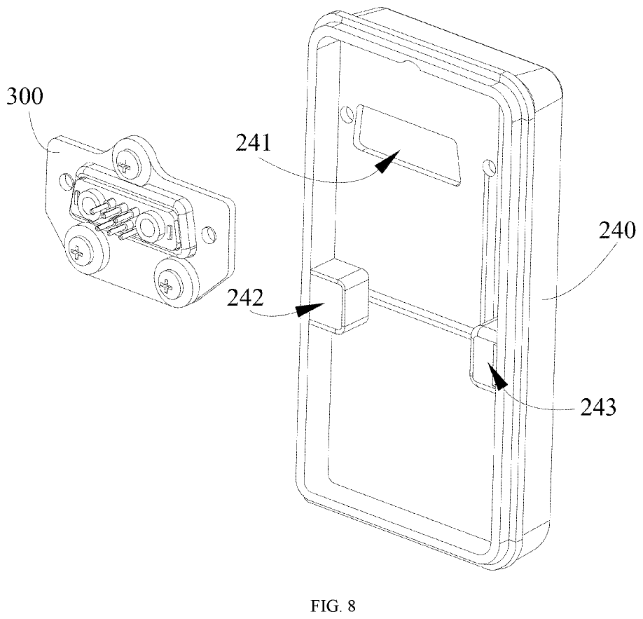

In some embodiments, as shown in FIGS. 6 and 8, the housing 200 includes a housing body 210, a first cover plate 220, a second cover plate 230, and a plug-in panel 240. The housing body 210 and the first cover plate 220 are connected to form a hollow structure having two opposite openings. The battery pack 100 is disposed inside the hollow structure. The second cover plate 230 covers one opening of the hollow structure. The plug-in panel 240 covers the other opening of the hollow structure. The plug-in panel 240 is provided with a panel through hole 241 penetrating through the plug-in panel 240, and the quick connector 300 is fixed in the panel through hole 241. In this way, the battery pack 100 is enclosed inside the housing 200 to protect the battery pack 100. The plug-in panel 240 is provided with the panel through hole 241 penetrating through the plug-in panel 240, and the quick connector 300 penetrates through the panel through hole 241. In this way, when the quick connector 300 is damaged, the quick connector 300 is able to be directly removed and replaced, without replacing the entire housing 200, so as to reduce the maintenance cost of the battery module of the battery-replacement outdoor power supply. In addition, the quick connector 300 has a self-positioning structure, which is able to be quickly and accurately installed to the panel through hole 241, and is convenient for an external electrical connector to be connected with the quick connector 300.

In some embodiments, as shown in FIG. 8, the plug-in panel 240 is provided with a third card slot 242 and a fourth card slot 243. Both the third card slot 242 and the fourth card slot 243 may be equipped with a DC unit or an AC unit, so that the battery module of the battery-replacement outdoor power supply is able to output DC or AC power so as to be used as an independent power supply, thereby expanding the application scenario of the battery module.

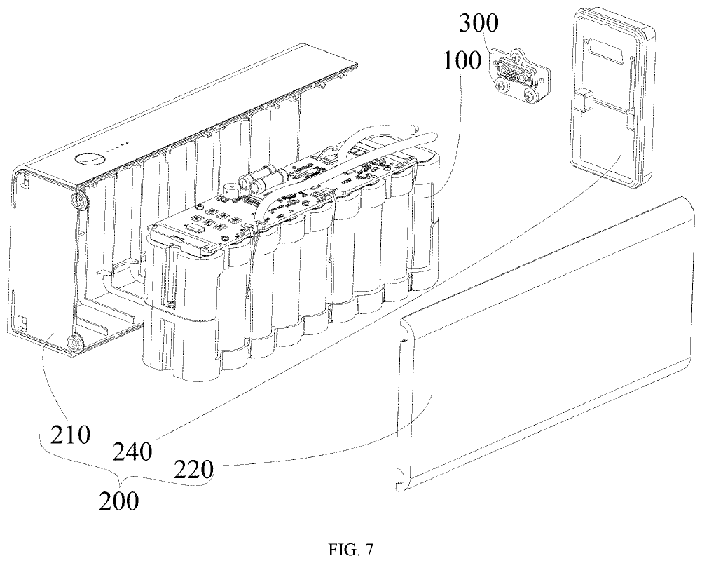

In some embodiments, as shown in FIGS. 6 and 7, the second cover plate 230 is integrally formed with the housing body 210. In this case, the housing 200 includes the housing body 210, the first cover plate 220, and the plug-in panel 240. The housing body 210 and the first cover plate 220 are connected to form a hollow structure having an opening. The inner space of the hollow structure is used for accommodating the battery pack 100. The plug-in panel 240 covers the opening of the hollow structure. The second cover plate 230 is integrally formed with the housing body 210 so that the structural strength of the housing 200 is improved, thereby providing better protection for the battery pack 100.

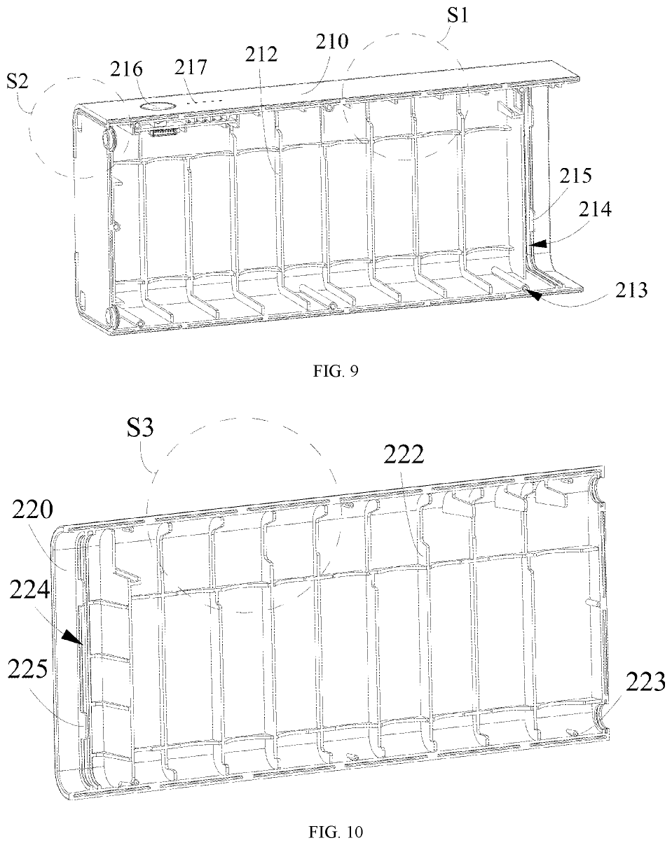

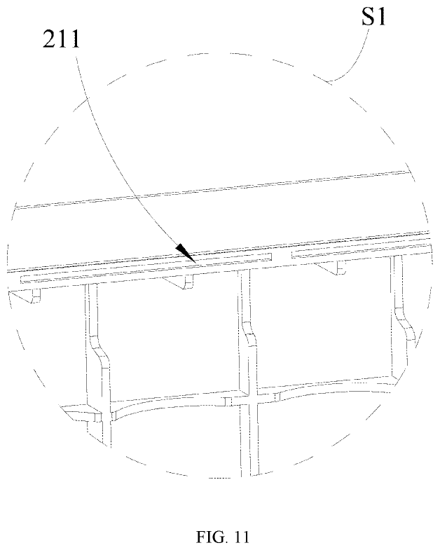

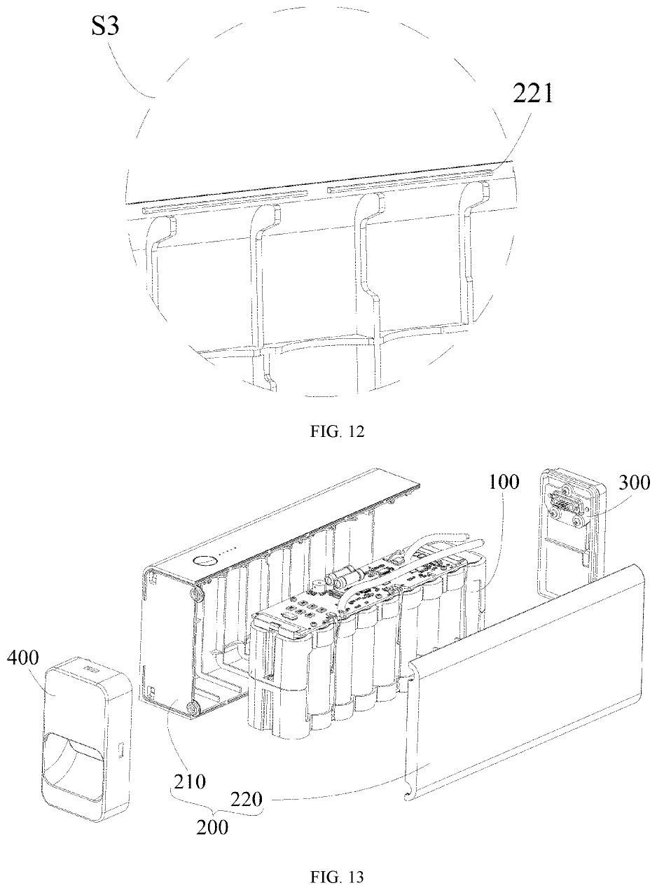

In some embodiments, as shown in FIGS. 9 to 12, the housing body 210 is provided with a plurality of positioning grooves 211, the first cover plate 220 is provided with a plurality of positioning protrusions 221, the plurality of positioning protrusions 211 are in one-to-one correspondence with the plurality of positioning grooves 221, and the plurality of positioning protrusions 211 are respectively embedded in the plurality of positioning grooves 221. By the matching of the positioning protrusions 211 and the positioning grooves 221, the assembly accuracy of the housing body 210 and the first cover plate 220 is improved, and the overall structural strength of the housing 200 is improved.

In some embodiments, the number of the positioning grooves 211 may be larger than the number of the positioning protrusions 221 as long as there are positioning grooves 211 corresponding to the positioning protrusions 221 for the positioning protrusions 221 being able to be embedded in the positioning grooves 211, thereby improving the assembly accuracy of the housing body 210 and the first cover plate 220, which is not specifically limited in the embodiments of the present disclosure.

In some embodiments, as shown in FIGS. 9 and 10, an inner wall surface of the housing body 210 facing the battery pack 100 is provided with at least one first reinforcing rib 212, and an inner wall surface of the first cover plate 220 facing the battery pack 100 is provided with at least one second reinforcing rib 222. The provision of the at least one first reinforcing rib 212 on the inner wall surface of the housing body 210 facing the battery pack 100 improves the structural strength of the housing body 210, and the provision of the at least one second reinforcing rib 222 on the inner wall surface of the first cover plate 220 facing the battery pack 100 improves the structural strength of the first cover plate 220. In this way, the strength of the housing body 210 and first cover plate 220 is improved through the reinforcing ribs 212, 222, so as to form stable protection for the battery pack 100. In addition, the first reinforcing rib 212 and the second reinforcing rib 222 are able to abut the battery pack 100 so as to fix the battery pack 100 and prevent the battery pack 100 from being displaced.

In some embodiments, as shown in FIGS. 9 and 10, both the number of first reinforcing ribs 212 and the number of second reinforcing ribs 222 are plural. The plurality of first reinforcing ribs 212 are in one-to-one correspondence with the plurality of second reinforcing ribs 222, and the first reinforcing ribs 212 are respectively abut against the second reinforcing ribs 222. When the housing body 210 is connected to the first cover plate 220, the first reinforcing ribs 212 are in one-to-one correspondence with the second reinforcing ribs 222 and abut against each other. In this way, the assembly accuracy of the housing body 210 and the first cover plate 220 is improved, and the structural strength of the housing 200 is improved.

In some embodiments, the number of the first reinforcing ribs 212 and the number of the second reinforcing ribs 222 may be different as long as the assembly strength of the housing body 210 and the first cover plate 220 is able to be increased by providing the reinforcing ribs and the structural strength of the housing 200 is able to be provided, which are not specifically limited in the embodiments of the present disclosure.

In some embodiments, as shown in FIGS. 9 and 10, an inner wall surface of the housing body 210 facing the battery pack 100 is provided with a plurality of third positioning holes 213, and openings of the plurality of third positioning holes 213 facing the first cover plate 220. An inner wall surface of the first cover plate 220 facing the battery pack 100 is provided with a plurality of second positioning pillars 223, the plurality of third positioning holes 213 are in one-to-one correspondence with the plurality of second positioning pillars 223, and the plurality of second positioning pillars 223 are respectively embedded in the plurality of third positioning holes 213. In this way, the third positioning holes 213 are matched with the second positioning pillars 223 to fix the relative positions of the housing body 210 and the first cover plate 220. When the housing body 210 and the first cover plate 220 are welded, the relative positions of the housing body 210 and the first cover plate 220 are stabilized, thereby improving the assembly accuracy of the housing body 210 and the first cover plate 220, and improving the appearance effect of the housing 200.

In some embodiments, the number of the third positioning holes 213 may be larger than the number of the second positioning pillars 223, as long as the third positioning holes 213 are matched with the second positioning pillars 223 to fix the relative positions of the housing body 210 and the first cover plate 220. A connection mode of the housing body 210 and the first cover plate 220 may be adhesive connection, clamping or other connection modes, as long as the housing body 210 and the first cover plate 220 are tightly connected to protect the battery pack 100, which is not specifically limited in the embodiments of the present disclosure.

In some embodiments, as shown in FIGS. 9 and 10, an inner wall surface of the housing body 210 facing the battery pack 100 is provided with a first card slot 214 and a first rib position 215, and an inner wall surface of the first cover plate 220 facing the battery pack 100 is provided with a second card slot 224 and a second rib position 225. The first card slot 214, the first rib position 215, the second card slot 224 and the second rib position 225 are used to assemble the plug-in panel 240, so that the difficulty of positioning the plug-in panel 240 is reduced, and the assembly accuracy of the plug-in panel 240 is improved.

In some embodiments, as shown in FIG. 9, an outer wall surface of the housing body 210 facing away from the battery pack 100 is provided with a power switch 216 and an electric quantity display device 217. In this way, independent control of the battery module is realized through the power switch 216 during use. The user is also able to obtain a real-time electric quantity of the battery module through the electric quantity display device 217 to facilitate the user in determining the time for replacing the battery module.

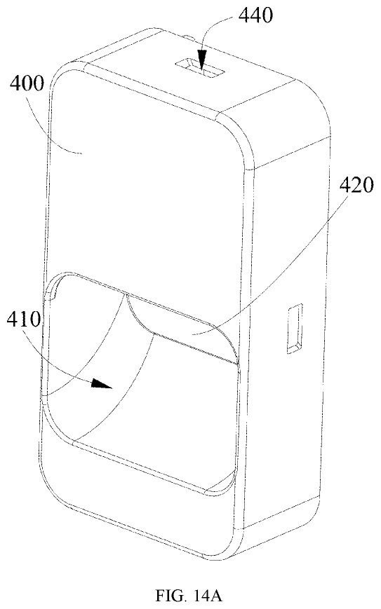

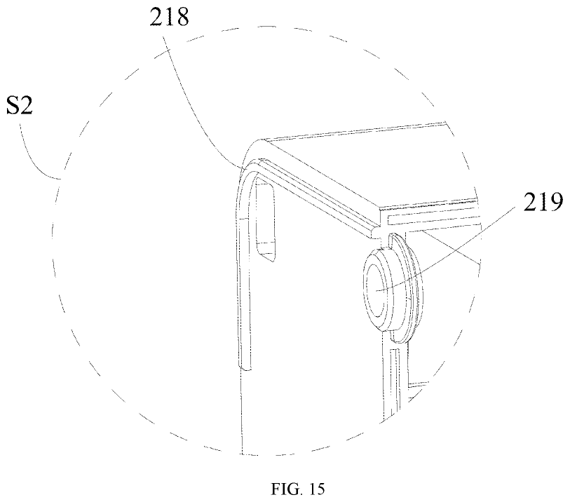

In some embodiments, as shown in FIGS. 13 to 15, the battery module of the battery-replacement outdoor power supply further includes a handle 400, and the handle 400 is connected to the second cover plate 230. The handle 400 is provided with a groove 410 having an opening exposed outside the hollow structure, and the groove 410 is provided with a guide mechanism 420. When the user disassembles or installs the battery module of the battery-replacement outdoor power supply, the handle 400 is able to provide a grasping space for the user, and the guide mechanism 420 is able to guide fingers of the user to an operating position accurately, so as to grasp the handle 400 smoothly, thereby improving the use experience of the handle 400. The handle 400 is independent from the housing 200 and is then connected to the housing 200, so that only one of the handle 400 and the housing 200 needs to be replaced when the handle 400 or the housing 200 is damaged, without replacing them all, thereby saving the cost.

In some embodiments, the handle 400 may be connected to the housing body 210 as the second cover plate 230, which may be adjusted according to the actual situation, which is not specifically limited in the embodiments of the present disclosure.

For example, the handle 400 may be connected to the second cover plate 230. As shown in FIGS. 13 to 15, the outer wall surface of the housing body 210 facing away from the battery pack 100 is provided with positioning ribs 218 and fixing holes 219. A side of the handle 400 facing the second cover plate 230 is provided with fixing pillars 430. Each of the fixing pillars 430 is embedded in a respective fixing hole 219. The positioning ribs 218 and the fixing holes 219 are used to assemble the handle 400. The positioning ribs 218 have the positioning functions, and the fixing pillars 430 in cooperation with the fixing holes 219 also have a function of preventing misoperation, which ensures the handle 400 correctly installed, and improves the assembly accuracy of the handle 400.

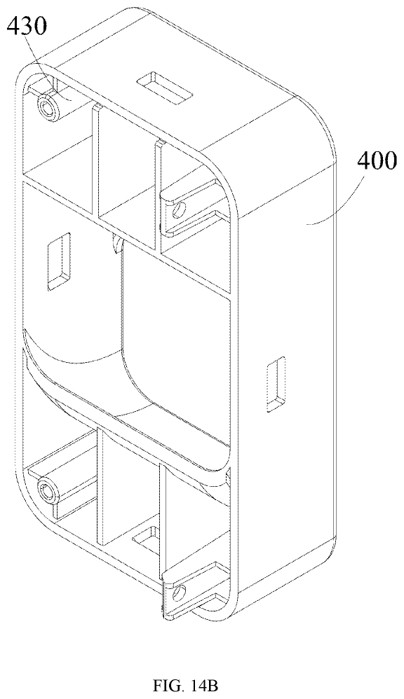

In some embodiments, as shown in FIG. 14, the handle 400 is provided with lock holes 440 respectively on outer wall surfaces adjacent to a surface where the groove 410 is provided, and each of the lock holes 440 is used to cooperate with a respective lock catch in the battery compartment of the battery-replacement outdoor power supply so as to fix the battery module. In this way, when the battery module of the battery-replacement outdoor power supply is installed in the battery-replacement outdoor power supply, the lock holes 440 and the lock catches cooperate to fix the battery module, so as to prevent the battery module from being separated from the battery-replacement outdoor power supply and ensure continuous power supply of the battery-replacement outdoor power supply

In some embodiments, the upper cell bracket 150, the lower cell bracket 160, the housing body 210, the first cover plate 220, the second cover plate 230, the plug-in panel 240, and the handle 400 of the battery module of the battery-replacement outdoor power supply are all made of ABS/PC material, so as to ensure high strength while also having high flame retardancy, thereby increasing the safety of the battery module. In some embodiments, the upper cell bracket 150, the lower cell bracket 160, the housing body 210, the first cover plate 220, the second cover plate 230, the plug-in panel 240, and the handle 400 may be made from aluminum profiles, provided that the housing 200 assembled from the upper cell bracket 150, the lower cell bracket 160, the housing body 210, the first cover plate 220, the second cover plate 230, and the plug-in panel 240 has sufficient strength, closeness, and flame retardancy, and the handle 400 has sufficient strength, which is not specifically limited in the embodiments of the present disclosure.

The above describes in detail the battery module of the battery-replacement outdoor power supply provided in the embodiments of the present disclosure. The principle and the embodiments of the present disclosure are described by using specific examples in the specification. The description of the embodiments is merely used to help understand the concept of the present disclosure, and the specific implementation and the application scope may be changed. In conclusion, the content of the specification should not be understood as a limitation on the present disclosure.

What is claimed is:

1. A battery module of a battery-replacement outdoor power supply for being incorporated into a battery compartment of the battery-replacement outdoor power supply, comprising:
a battery pack;
a housing;
a quick connector penetrating through the housing, wherein one end of the quick connector is electrically connected to the battery pack, and the other end of the quick connector is detachably connected to a slot in the battery compartment.

2. The battery module of the battery-replacement outdoor power supply according to claim 1, wherein the housing comprises a housing body, a first cover plate, a second cover plate and a plug-in panel;
wherein the housing body is a groove having openings, the first cover plate is connected to the housing body, the housing body and the first cover plate corporately form a hollow structure having two opposite openings, and the battery pack is disposed inside the hollow structure; and
wherein the second cover plate covers one of the two opposite openings of the hollow structure, the plug-in panel covers the other of the two opposite openings of the hollow structure, the plug-in panel is provided with a panel through hole through the plug-in panel, and the quick connector is fixed in the panel through hole.

3. The battery module of the battery-replacement outdoor power supply according to claim 1, further comprising: a handle, wherein the handle is provided with a groove having an opening exposed outside the hollow structure, and the groove is provided with a guide mechanism; and wherein the handle is integrated with the housing body or connected to one of the second cover plate, the housing body, and the first cover plate.

4. The battery module of the battery-replacement outdoor power supply according to claim 3, wherein the handle is provided with lock holes respectively on outer wall surfaces adjacent to a surface where the groove is provided, and wherein each of the lock holes is configured to fitting and fixing a respective lock catch in the battery compartment.

5. The battery module of the battery-replacement outdoor power supply according to claim 2, wherein the housing body is provided with positioning grooves and the first cover plate is provided with positioning protrusions, and wherein the positioning protrusions are in one-to-one correspondence with the positioning grooves, and each of the positioning protrusions is embedded in a respective positioning groove.

6. The battery module of the battery-replacement outdoor power supply according to claim 2, wherein an inner wall surface of the housing body facing the battery pack is provided with at least one first reinforcing rib, and an inner wall surface of the first cover plate facing the battery pack is provided with at least one second reinforcing rib.

7. The battery module of the battery-replacement outdoor power supply according to claim 6, wherein a plurality of first reinforcing ribs and a plurality of second reinforcing ribs are provided, and wherein the plurality of first reinforcing ribs are in one-to-one correspondence with the plurality of second reinforcing ribs, and each of the plurality of first reinforcing ribs abuts a respective second reinforcing rib.

8. The battery module of the battery-replacement outdoor power supply according to claim 1, wherein the battery pack comprises a battery control board, a plurality of cells, a connection conductor and a plurality of insulating sheets, and the plurality of cells constitute a cell pack; wherein the cell pack has a positive electrode and a negative electrode opposite to each other, and the connection conductor comprises a positive electrode connection conductor, a negative electrode connection conductor and a plurality of series connection conductors; wherein the positive electrode connection conductor is connected to the positive electrode of the cell pack and is disposed at one end of the cell pack, the negative electrode connection conductor is connected to the negative electrode of the cell pack and is disposed at the other end of the cell pack opposite to the positive electrode connection conductor, and each of the plurality of series connection conductors is disposed at opposite sides of the cell pack and is configured for series connection of the plurality of cells;
wherein the battery control board is disposed at a side of the positive electrode connection conductor facing away from the cell pack and a side of the negative electrode connection conductor facing away from the cell pack, the battery control board is connected to the positive electrode connection conductor and the negative electrode connection conductor, the battery control board is connected to each of the plurality of cells, and the battery control board is connected to the quick connector; and
wherein the plurality of insulating sheets comprises a first insulating sheet, a second insulating sheet, and a third insulating sheet, wherein the first insulating sheet is sandwiched between the positive electrode connection conductor and the battery control board and extends from the positive electrode connection conductor to the negative electrode connection conductor, the second insulating sheet is disposed between the negative electrode connection conductor and the battery control board, and the third insulating sheet is disposed at a side of the cell pack facing away from the battery control board and sandwiched between the plurality of series connection conductor and an inner wall of the housing.

9. The battery module of the battery-replacement outdoor power supply according to claim 8, wherein the battery pack further comprises an upper cell bracket and a lower cell bracket, and wherein the upper cell bracket and the lower cell bracket define an accommodation space, and the plurality of cells are disposed in the accommodation space.

10. The battery module of the battery-replacement outdoor power supply according to claim 9, wherein the housing is further provided with a power switch and an electric quantity display device.
